(19) United States
(12) Patent Application Publication
(10) Pub. No.: US 2014/0366389 A1
(43) Pub. Date: Dec. 18, 2014

(54) Substrate Specific Cutting Guide

(71) Applicants: Robert Bosch Tool Corporation, Broadview, IL (US); Robert Bosch GmbH, Stuttgart (DE)

(72) Inventors: Christopher Weiland, Glenview, IL (US); Patrick Sean Gallagher, Arlington Heights, IL (US)

(21) Appl. No.: 14/470,792

(22) Filed: Aug. 27, 2014

Related U.S. Application Data
(62) Division of application No. 13/341,507, filed on Dec. 30, 2011.

(51) Int. Cl. B27B 9/02; B27B 9/00

(52) U.S. Cl. CPC B27B 9/02; B27B 9/00
USPC 30/377

(57) ABSTRACT

A cutting guide for a saw, the guide comprising: (a) a guide including a follower path, the guide including a plurality of indicia each representative of a plurality of different substrates; (b) a follower repositionable with respect to the guide along the follower path and into alignment with at least one of the plurality of indicia; and, (c) a lock operatively coupled to the follower, the lock being repositionable between a locked position and an unlocked position, the locked position operative to retain the guide in a fixed position with respect to the follower, and the unlocked position operative to allow a relative position of the guide with respect to the follower to be changed.

This application is a divisional application of co-pending application Ser. No. 13/341,507, filed on Dec. 30, 2011, the disclosure of which his hereby totally incorporated by reference in its entirety

### FIELD OF THE INVENTION

The present invention generally relates to power tools and particularly to power hand tools having a cutting guide.

### BACKGROUND

Power hand tools such as miter saws, circular saws, as well as other hand tools are often provided with the capability of adjusting the depth of cut or the bevel angle. Where such adjustability is provided in a tool, there is generally a measurement display or indicator present on the tool that will enable the user to set the angle or depth of cut at the desired location that is substrate independent.

### SUMMARY

It is a first aspect of the present invention to provide a cutting guide for a saw, the guide comprising: (a) a guide including a follower path, the guide including a plurality of indicia each representative of a plurality of different substrates; (b) a follower repositionable with respect to the guide along the follower path and into alignment with at least one of the plurality of indicia; and, (c) a lock operatively coupled to the follower, the lock being repositionable between a locked position and an unlocked position, the locked position operative to retain the guide in a fixed position with respect to the follower, and the unlocked position operative to allow a relative position of the guide with respect to the follower to be changed.

In a more detailed embodiment of the first aspect, the guide comprises an arcuate loop that defines the follower path, the follower path is partially defined by a through opening having a substantially constant radius of curvature, and a plurality of indicia are spaced apart from one another along a length of the arcuate loop. In yet another more detailed embodiment, the follower includes an arcuate segment, and the plurality of indicia comprise spaced apart arcuate markings that each approximate an arc of the arcuate segment. In a further detailed embodiment, the plurality of indicia include a plurality of numerical identifiers that are substrate specific. In still a further detailed embodiment, the plurality of indicia represent at least one of the same material with differing thicknesses and different materials. In a more detailed embodiment, the guide is repositionable with respect to the follower, the follower has a fixed position, and the lock in the locked position is operative to form a wedge in between the guide and follower to retain the guide in the fixed position with respect to the follower.

It is a second aspect of the present invention to provide a power saw comprising: (a) a motor coupled to a motor housing, the motor housing including a handle and a trigger; (b) a base plate repositionably mounted to the motor housing; (c) a guide coupled to the base plate, the guide defining a follower path, the guide including a plurality of indicia each representative of a plurality of different substrates; (d) a follower coupled to at least one of the motor and motor housing, the follower repositionable with respect to the guide along the follower path and into alignment with at least one of the plurality of indicia; and, (e) a lock operatively coupled to the follower, the lock being repositionable between a locked position and an unlocked position, the locked position operative to retain the guide in a fixed position with respect to the follower, and the unlocked position operative to allow a relative position of the guide with respect to the follower to be changed.

In a more detailed embodiment of the second aspect, the guide comprises an arcuate loop that defines the follower path, the follower path is partially defined by a through opening having a substantially constant radius of curvature, and a plurality of indicia are spaced apart from one another along a length of the arcuate loop. In yet another more detailed embodiment, the follower includes an arcuate segment, and the plurality of indicia comprise spaced apart arcuate markings that each approximate an arc of the arcuate segment. In a further detailed embodiment, the plurality of indicia include a plurality of numerical identifiers that are substrate specific. In still a further detailed embodiment, the plurality of indicia represent at least one of the same material with differing thicknesses and different materials. In a more detailed embodiment, the guide is repositionable with respect to the follower, the follower has a fixed position, and the lock in the locked position is operative to form a wedge in between the guide and follower to retain the guide in the fixed position with respect to the follower.

It is a third aspect of the present invention to provide a power saw comprising: (a) a motor coupled to a motor housing, the motor housing including a handle and a trigger; (b) a base plate repositionably mounted to the motor housing; (c) a guide coupled to at least one of the motor and motor housing, the guide defining a follower path, the guide including a plurality of indicia each representative of a plurality of different substrates; (d) a follower coupled to the base plate, the follower repositionable with respect to the guide along the follower path and into alignment with at least one of the plurality of indicia; and, (e) a lock operatively coupled to the follower, the lock being repositionable between a locked position and an unlocked position, the locked position operative to retain the follower in a fixed position with respect to the guide, and the unlocked position operative to allow a relative position of the follower with respect to the guide to be changed.

In a more detailed embodiment of the third aspect, the guide comprises an arcuate loop that defines the follower path, the follower path is partially defined by a through opening having a substantially constant radius of curvature, and a plurality of indicia are spaced apart from one another along a length of the arcuate loop. In yet another more detailed embodiment, at least one of the lock and the follower includes an arcuate segment, and the plurality of indicia comprise spaced apart arcuate markings that each approximate an arc of the arcuate segment. In a further detailed embodiment, the plurality of indicia include a plurality of numerical identifiers that are substrate specific. In still a further detailed embodiment, the plurality of indicia represent at least one of the same material with differing thicknesses and different materials. In a more detailed embodiment, the follower is repositionable with respect to the guide, the guide has a fixed position, and the lock in the locked position is operative to form a wedge in between the guide and follower to retain the follower in the fixed position with respect to the guide.

It is a fourth aspect of the present invention to provide a method of providing a cutting guide for a power saw, the method comprising: (a) providing a guide that includes a plurality of substrate-specific indicia representative of a plurality of different substrates that may be cut by the power saw; and, (b) providing a follower that is relatively repositionable with respect to the guide to notify a user when the power saw is properly configured to cut through one of the plurality of different substrates when the follower is aligned with at least one of the plurality of substrate-specific indicia.

In a more detailed embodiment of the fourth aspect, the method further includes the act of providing a lock to fix the relative positions of the follower with respect to the guide to maintain the proper configuration of the power saw.

### BRIEF DESCRIPTION OF THE DRAWINGS

FIG. 1 is an elevated perspective view from the rear, left side of a circular saw incorporating the exemplary cutting guide in accordance with the present invention;

FIG. 2 is an elevated perspective view from the rear, right side of the circular saw of FIG. 1;

FIG. 3 is an elevated perspective view of an exemplary guide for use with the circular saw of FIG. 1.

### DETAILED DESCRIPTION

The exemplary embodiments of the present disclosure are described and illustrated below to encompass guides for cutting saws and methods of guiding a user of a cutting saw to ensure the cutting saw is properly configured. Of course, it will be apparent to those of ordinary skill in the art that the embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure.

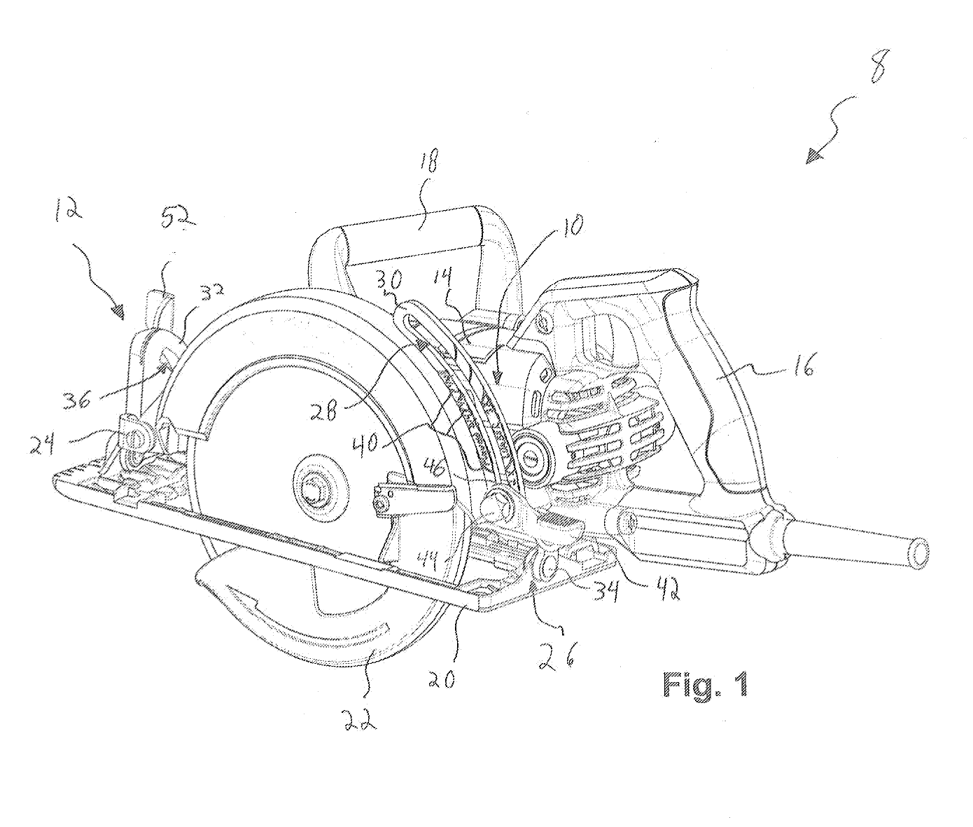

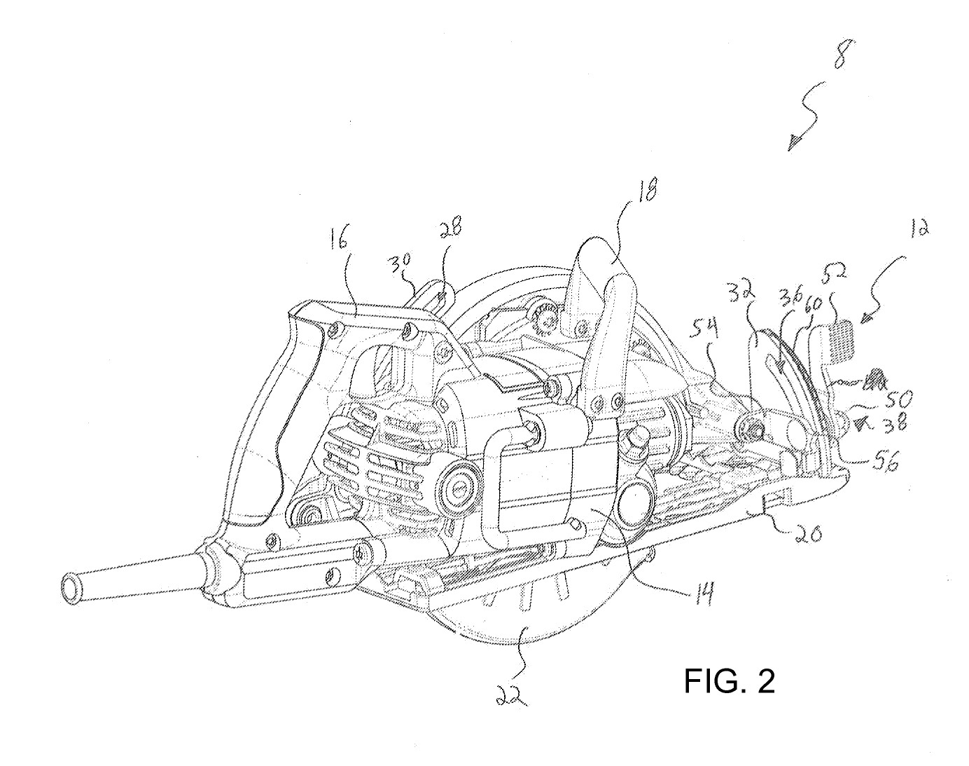

Referencing FIGS. 1 and 2, an exemplary circular saw 8 is illustrated and generally shows a cutting guide 10 and a bevel guide 12. Both guides 10, 12 are implemented in exemplary form with a circular saw 8 having a motor housing 14, a handle 16, an auxiliary handle 18, a foot 20, as well as a blade housing 22 in which a saw blade is located.

The saw 8 may be adjusted to ensure the saw is properly configured to completely cut through one of a plurality of different substrates. As used herein, substrate refers to any physical medium that may be severed by a saw. By way of example, and not limitation, a piece of wood having dimensions of 1.5 inches by 3.5 inches by some length dimension (commonly known as a 2×4) would be substrate, while another piece of wood having dimensions of 1.5 inches by 5.5 inches by some length dimension (commonly known as a 2×6) would be different substrate even though both substrates are fabricated from the same material. Likewise, different substrates may have the same dimensions but be fabricated from different materials (e.g., wood vs. wood & glue or wood vs. stone).

In order to properly configure the saw, a user may utilize the cutting guide 10. This cutting guide 10 allows the saw blade (not shown), the saw blade housing 22, and the motor housing 14 to pivot around an axis defined by a bolt 24. A lock 26 is coupled to the handle 16 and rides within an arcuate slot 28 provided in a generally arcuate bracket 30 that is mounted to the motor housing 14 by bolts, screws, or other structure known to those of ordinary skill in the art.

Similarly, the angle of the saw blade can be adjusted by using bevel guide 12. The bevel guide 12 includes a bevel bracket 32 that may be integrally formed with the foot structure 20. The saw blade housing 22, which is mounted to the motor housing 14, is operative to change its orientation with respect to the foot structure 20 by way of pivoting around an axis defined by a bolt 34. An arcuate slot 36 within the bevel bracket 32 is configured to have a constant radius of curvature with respect to the bolt 34 and a locking lever 38 enables the bevel angle to be locked in place after a user has set the proper bevel angle.

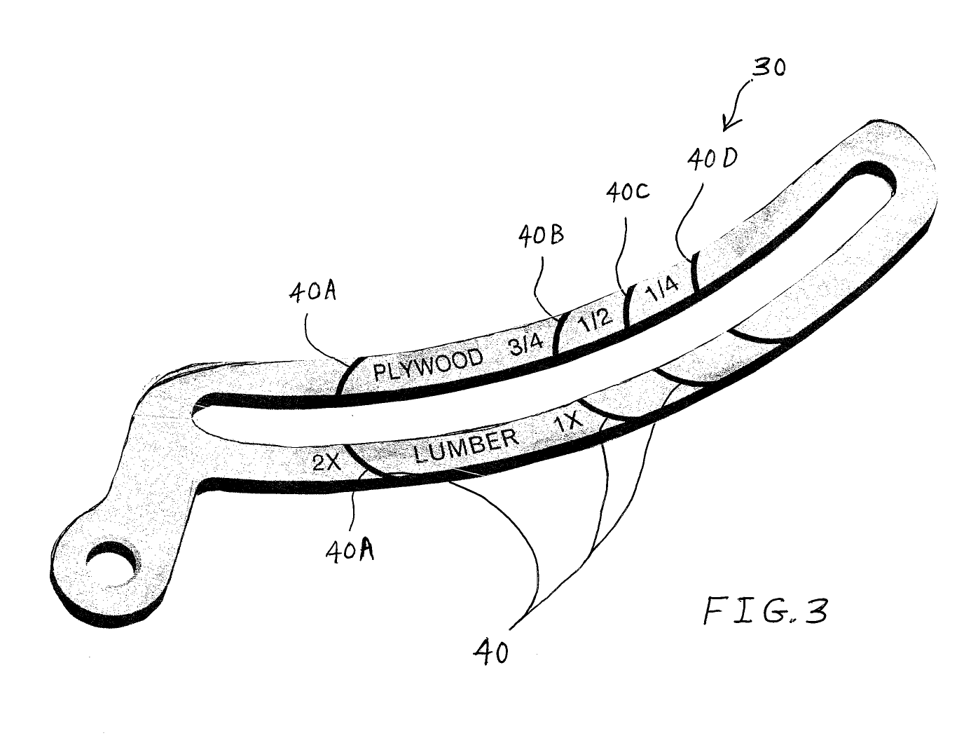

Turning now to FIGS. 1-3, concerning the cutting guide 10, the bracket 30 includes a number of arcuate markings 40 along the longitudinal length of the bracket. These longitudinal markings correspond to the position of the saw blade operative to completely cut through different substrates. For instance, in exemplary form, the arcuate markings 40 are provided in a set of four paired markings. The first paired markings 40A denote the position of the blade operative to cut completely through two inch lumber. In exemplary form, this first paired markings 40A include a numerical identifier “2×”, indicating that blade is set to cut two inch lumber. The second paired markings 40B denote the position of the blade operative to cut completely through three-quarter inch plywood or one inch lumber. In exemplary form, this second paired markings 40B include two numerical identifiers “¾” and “1×”, indicating that blade is set to cut three quarter inch plywood or one inch lumber. The third paired markings 40C denote the position of the blade operative to cut completely through one-half inch plywood. In exemplary form, this third paired markings 40C include a numerical identifier “½”, indicating that blade is set to cut one-half inch plywood. The fourth paired markings 40D denote the position of the blade operative to cut completely through one-quarter inch plywood. In exemplary form, this fourth paired markings 40D include a numerical identifier “¼”, indicating that blade is set to cut one-quarter inch plywood. It should be noted that the markings to not numerically represent an actual depth of the blade, such as in prior art guides, but rather provide markings that confirm the blade is positioned to cut completely through the material with a predetermined undercut. In other words, the guide represents a numerical figure comprises of the depth of the material to be cut in addition to a predetermined undercut value (a depth of the blade that goes beyond (underneath) the substrate to be cut). And it should also be noted that any form of indicia may be used to indicate the position of the guide that is operative to cut through a particular substrate.

Referring back to FIGS. 1 and 2, the locking lever 26 includes a lever handle 42 and a bolt 44 (i.e., threaded stud, carriage bolt or the like) that extends through the lever handle and into a threaded cavity of the motor housing 14. In this manner, the lever handle 42 is pivotable around the bolt 44, which extends through the arcuate bracket 30 and into engagement with the motor housing 14.

Referencing FIGS. 1-3, each set of markings 40 includes the same arc as the circumferential arc 46 of the lever handle 42. As a result, when the lever handle 42 is positioned so that a pair of arcuate markings 40 are just outside of the portion of the lever handle with the circumferential arc 46, the user of the saw knows that the position of the saw blade is configured to cut through the particular material denoted on the marking. But the lock 26 must be secured to maintain the position of the saw blade with respect to the foot 20.

Rotation of the lever handle 42 in the clockwise direction effects rotation of the bolt 44 in the same direction, thereby forming a wedge operative to clamp the bracket 30 between the lever handle and the motor housing to the blade housing 22. This wedge is operative to fix the relative positions of the motor housing 14 and the blade housing 22 with respect to the foot 20. Conversely, when the lever handle 42 is moved in a counterclockwise direction, the bolt 44 also turns in a counterclockwise direction, thereby discontinuing the clamp. Once the clamp is discontinued and a sufficient gap exists, the motor housing 14 and the blade housing 22 may be repositioned with respect to the foot 20 to change the position of the blade.

Thus, in summary, the arcuate bracket 30 is mounted to the foot 20 and is configured so that the locking lever mechanism 26 may engage and reciprocate within the slot 28 disposed within the bracket. In exemplary form, the arcuate bracket 30 includes an elongated through hole that receives the bolt 44. The arcuate profile of this through hole provides a constant radius of curvature to match the pivoting action of the foot 20 with respect to the motor housing 14. In this exemplary embodiment, the arcuate bracket 30 is vertically and horizontally repositionable with respect to the bolt 44 as a result of the pivoting action of the foot 20 with respect to the motor housing 14. Because the bolt 44 is rotationally repositionable, but not vertically or horizontally repositionable, one can consider the bolt to have a fixed position relative to the motor housing 14, while the arcuate guide has a variable position with respect to the motor housing.

In contrast to the foregoing explanation and depiction shown in FIGS. 1 and 2, it is also within the scope of the invention to switch the bolt 44 and arcuate bracket 30 so that the arcuate bracket is fixed in position, while the bolt has a variable position. In exemplary form, the arcuate bracket 30 is mounted to the motor housing 14, while the bolt 44 is mounted to the foot 20. In this manner, the bolt 44 is vertically and horizontally repositionable to ride within the through opening.

Turning now to the bevel guide 12, the bevel bracket 32 has the slot 36 as previously described through which a threaded fastener 50 (i.e., a carriage bolt, stud or the like) extends. The threaded fastener 50 also extends through an opening in a repositionable bevel handle 52 on one side of the bevel bracket 32, while at the same time the threaded fastener extends into a cavity of a mounting bracket 54 coupled to the saw blade housing 22. In this manner, the bevel handle 52 is pivotable around the threaded fastener 50. And rotation of the bevel handle 52 in the clockwise direction as illustrated in FIG. 1 effects rotation of the foot 20 and bevel bracket 32 with respect to the motor housing 14, the blade housing 22, and the mounting bracket 54, thereby clamping the bracket 32 between the bevel handle and the bevel bracket. This clamping is operative to fix the relative positions of the foot 20 and bevel bracket 32 with respect to the motor housing 14, the blade housing 22, and the mounting bracket 54. Conversely, when the bevel handle 52 is moved in a counterclockwise direction with reference to FIG. 1, the threaded fastener 50 also turns in a counterclockwise direction, thereby discontinuing the clamp. Once the clamp is discontinued and a sufficient gap exists, the foot 20 and bevel bracket 32 may be repositioned with respect to the motor housing 14, the blade housing 22, and the mounting bracket 54 to vary the bevel angle of cut of the blade. Thus, in summary, the bevel bracket 32 is mounted to the foot 20 and is configured so that the threaded fastener 50 may engage and reciprocate within the slot 36 disposed within the bracket.

The bevel bracket 32 includes a number of markings 60 along the longitudinal length of the bracket. These longitudinal markings correspond to the angle of the saw blade with respect to the foot 20. For instance, in exemplary form, the markings 60 are provided in nineteen paired markings. Each paired marking 60 denotes the angular position of the blade with respect to the foot 20 using five degree increments.

For example, the first paired marking 60 denotes a zero degree beveled angle between the saw blade and the foot 20, while the nineteenth paired marking denotes a ninety degree beveled angle between the saw blade and the foot. As a result, when the bevel handle 52 is positioned so that a pair of markings 60 are aligned with pointer 56 of the mounting bracket 54, the user it provided with a guide indicating the angle at which the blade is oriented with respect to the foot 20, which also corresponds to the angle at which the blade is oriented with respect to a planar substrate (adjacent and flat against the foot 20) to be cut.

Following from the above description and invention summaries, it should be apparent to those of ordinary skill in the art that, while the methods and apparatuses herein described constitute exemplary embodiments of the present invention, the invention is not limited to the foregoing and changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A cutting guide for a saw, the guide comprising:
a guide including a follower path, the guide including a plurality of indicia, each of which is representative of one substrate of a plurality of different substrates;
a follower repositionable with respect to the guide along the follower path and into alignment with at least one of the plurality of indicia; and,
a lock operatively coupled to the follower, the lock being repositionable between a locked position and an unlocked position, the locked position operative to retain the guide in a fixed position with respect to the follower, and the unlocked position operative to allow a relative position of the guide with respect to the follower to be changed,
wherein the follower includes an arcuate segment, and
wherein the plurality of indicia comprise spaced apart arcuate markings that each approximate an arc of the arcuate segment.

2. The cutting guide of claim 1, wherein:
the guide comprises an arcuate loop that defines the follower path;
the follower path is partially defined by a through opening having a substantially constant radius of curvature; and
the plurality of indicia are spaced apart from one another along a length of the arcuate loop.

3. The cutting guide of claim 2, wherein:
each indicia of the plurality of indicia includes a first arc portion on a first side of the through opening and a second arc portion on a second side of the through opening; and
a radius of each of the spaced apart arcuate markings corresponds to a radius of the arcuate segment such that aligning the arcuate segment with the first and second arc portions forms a continuous arc.

4. The cutting guide of claim 1, wherein the plurality of indicia include a plurality of numerical identifiers that are substrate specific.

5. The cutting guide of claim 1, wherein the plurality of indicia represent at least one of the same material with differing thicknesses and different materials.

6. The cutting guide of claim 1, wherein each indicia of the plurality of indicia corresponds to a position of a saw blade operably connected to the cutting guide such that the saw blade extends beyond a corresponding substrate of the plurality of different substrates by a predetermined undercut value.

7. The cutting guide of claim 1, wherein:
the guide is repositionable with respect to the follower;
the follower has a fixed position; and
the lock in the locked position is operative to form a wedge in between the guide and follower to retain the guide in the fixed position with respect to the follower.

8. A power saw comprising:
a motor coupled to a motor housing, the motor housing including a handle and a trigger;
a base plate repositionably mounted to the motor housing;
a guide coupled to the base plate, the guide defining a follower path, the guide including a plurality of indicia, each of which is representative of one substrate of a plurality of different substrates;
a follower coupled to at least one of the motor and motor housing, the follower repositionable with respect to the guide along the follower path and into alignment with at least one of the plurality of indicia; and,
a lock operatively coupled to the follower, the lock being repositionable between a locked position and an unlocked position, the locked position operative to retain the guide in a fixed position with respect to the follower, and the unlocked position operative to allow a relative position of the guide with respect to the follower to be changed,
wherein at least one of the lock and the follower includes an arcuate segment, and
wherein the plurality of indicia comprise spaced apart arcuate markings that each approximate an arc of the arcuate segment.

9. The power saw of claim 8, wherein:
the guide comprises an arcuate loop that defines the follower path;
the follower path is partially defined by a through opening having a substantially constant radius of curvature; and
the plurality of indicia are spaced apart from one another along a length of the arcuate loop.

10. The power saw of claim 9, wherein:
each indicia of the plurality of indicia includes a first arc portion on a first side of the through opening and a second arc portion on a second side of the through opening; and
a radius of each of the spaced apart arcuate markings corresponds to a radius of the arcuate segment such that aligning the arcuate segment with the first and second arc portions forms a continuous arc.

11. The power saw of claim 8, wherein the plurality of indicia include a plurality of numerical identifiers that are substrate specific.

12. The power saw of claim 8, wherein the plurality of indicia represent at least one of the same material with differing thicknesses and different materials.

13. The power saw of claim 8, wherein:
the guide is repositionable with respect to the follower;
the follower has a fixed position; and,
the lock in the locked position is operative to form a wedge in between the guide and follower to retain the guide in the fixed position with respect to the follower.

14. A power saw comprising:
a motor coupled to a motor housing, the motor housing including a handle and a trigger;
a base plate repositionably mounted to the motor housing;
a guide coupled to at least one of the motor and motor housing, the guide defining a follower path, the guide including a plurality of indicia, each of which is representative of one substrate of a plurality of different substrates;
a follower coupled to the base plate, the follower repositionable with respect to the guide along the follower path and into alignment with at least one of the plurality of indicia; and,
a lock operatively coupled to the follower, the lock being repositionable between a locked position and an unlocked position, the locked position operative to retain the follower in a fixed position with respect to the guide, and the unlocked position operative to allow a relative position of the follower with respect to the guide to be changed,
wherein at least one of the lock and the follower includes an arcuate segment, and
wherein the plurality of indicia comprise spaced apart arcuate markings that each approximate an arc of the arcuate segment.

15. The power saw of claim 14, wherein:
the guide comprises an arcuate loop that defines the follower path;
the follower path is partially defined by a through opening having a substantially constant radius of curvature; and
the plurality of indicia are spaced apart from one another along a length of the arcuate loop.

16. The power saw of claim 15 wherein:
each indicia of the plurality of indicia includes a first arc portion on a first side of the through opening and a second arc portion on a second side of the through opening; and
a radius of each of the spaced apart arcuate markings corresponds to a radius of the arcuate segment such that aligning the arcuate segment with the first and second arc portions forms a continuous arc.

17. The power saw of claim 14, wherein the plurality of indicia include a plurality of numerical identifiers that are substrate specific.

18. The power saw of claim 14, wherein the plurality of indicia represent at least one of the same material with differing thicknesses and different materials.

19. The power saw of claim 14, wherein:
the follower is repositionable with respect to the guide;
the guide has a fixed position; and,
the lock in the locked position is operative to form a wedge in between the guide and follower to retain the follower in the fixed position with respect to the guide.
